(19) United States
(12) Patent Application Publication
(10) Pub. No.: US 2016/0321664 A1
(43) Pub. Date: Nov. 3, 2016

(54) SYSTEM AND METHOD FOR SECURE TRANSACTIONS USING IMAGES

(71) Applicants: Ronald R. Erickson, Brooklyn, NY (US); Joel N. Bock, Teaneck, NJ (US); Michael A. Gonzalez, Jersey City, NJ (US)

(72) Inventors: Ronald R. Erickson, Brooklyn, NY (US); Joel N. Bock, Teaneck, NJ (US); Michael A. Gonzalez, Jersey City, NJ (US)

(21) Appl. No.: 15/141,778

(22) Filed: Apr. 28, 2016

Related U.S. Application Data
(60) Provisional application No. 62/158,489, filed on May 7, 2015.
(60) Provisional application No. 62/154,060, filed on Apr. 28, 2015.

(51) Int. Cl. G06Q 20/40; G03H 1/00

(52) U.S. Cl. CPC G06Q 20/409; G03H 1/0011

(57) ABSTRACT

Provided herein is a system and a method for secure transactions using images. Also provided herein is a system for authenticating a transaction which may comprise a server, the server configured to (a) receive a first transaction code from a smart device; (b) receive a second transaction code from the merchant; (c) receive a smart device identifier; (d) receive payment card information; (e) receive at least one image; (f) analyze the identifier to determine an entity associated with the smart device; (g) determine whether the entity is the user; (h) analyze the payment card information to determine whether the user is the owner of the payment card; (i) associate the transaction code to the user; (j) analyze the at least one image to determine whether the image is associated with the user, the payment card, the smart device, or any combination of the user, the payment card and the smart device; upon determining an association between the image and the user, and between the image and the smart device or the smart device and the user, send an authentication code to the smart device and to the merchant.

### CROSS REFERENCE TO RELATED APPLICATIONS

The present application claims the benefit of U.S. Provisional Application Ser. No. 62/158,489 filed 7 May 2015, and U.S. Provisional Application Ser. No. 62/154,060 filed 28 Apr. 2015; each of which is incorporated herein by reference in its entirety.

### BACKGROUND

The present disclosure relates generally to systems and methods for a secure networked verification system.

Presently, the amount of fraudulent transaction over the internet is increasing dramatically with the international adoption of smart cards and on-line transactions. The present levels of security and authentication are limited in the level of protection provided to consumers, vendors and financial institutions. Due to the limited level provided by single level of authentication, a new system is required to ensure that the user is not only authorized by the financial institution to engage in the transaction, but also that the device being used to initiate and complete the transaction is associated with the user. The system should be scalable, flexible, secure, reliable, resilient, geo-redundant, efficient and cost-effective.

### SUMMARY

A system for authenticating a transaction, may comprise a server, the server configured to receive (a) a first transaction code from a smart device, the first transaction code corresponding to at least one pending transaction between a user and a merchant, (b) receive a second transaction code from the merchant, the second transaction code corresponding to the at least one pending transaction between the user and the merchant, (c) receive a smart device identifier, the identifier identifying the smart device, wherein the identifier corresponding to the user, a payment card, or both the user and the payment card, (d) receive payment card information, including information corresponding to an owner of the payment card, (e) receive at least one image, the at least one image corresponding to the payment card, the user, or both the payment card and the user, (f) analyze the identifier to determine an entity associated with the smart device, (g) determine whether the entity is the user, (h) analyze the payment card information to determine whether the user is the owner of the payment card, (i) associate the transaction code to the user, (j) analyze the at least one image to determine whether the image is associated with the user, the payment card, the smart device, or any combination of the user, the payment card and the smart device, and upon determining an association between the image and the user, and between the image and the smart device or the smart device and the user, send an authentication code to the smart device and to the merchant.

In one or more embodiments, the image is a photograph of a hologram. In one or more other embodiments, the smart device includes a camera for obtaining the image. In one or more embodiments, the system uses a hash file in place of a hologram image for authentication purposes. In one or more embodiments, the system uses an audio file in place of a hologram image for authentication purposes.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows a secure network verification system according to an embodiment of the present disclosure.

FIG. 2 shows a hologram manufacturer interconnectivity with a secure network verification system according to an embodiment of the present disclosure.

FIG. 3 shows a financial system interconnectivity of a secure network verification system according to an embodiment of the present disclosure.

FIG. 4 shows depicts a distributed infrastructure of an authentication system in accordance with an embodiment of the present disclosure.

FIG. 5 shows a layer of advanced encryption data protection for web services environments according to an embodiment of the present disclosure.

FIG. 6 shows a secure network verification system according to another embodiment of the present disclosure.

FIG. 7 shows capabilities and features of SIEM 600 in accordance with an embodiment of the present disclosure.

FIG. 8 shows an exemplary dashboard in accordance with an embodiment of the present disclosure.

FIG. 9 shows an exemplary alert and status display in accordance with an embodiment of the present disclosure.

FIG. 10 shows an exemplary analyses display in accordance with an embodiment of the present disclosure.

FIG. 11 shows a geo-redundant architecture of a system in accordance with an embodiment of the present disclosure.

### DETAILED DESCRIPTION

The present disclosure is herein described in detail with reference to embodiments illustrated in the drawings, which form a part hereof. Other embodiments may be used and/or other changes may be made without departing from the spirit or scope of the present disclosure. The illustrative embodiments described in the detailed description are not meant to be limiting of the subject matter presented here.

The present system provides a secure network verification system to be implemented on mobile or networked devices. The system and methods may include mobile device applications for various operating systems, including iOS, Android, Windows and the like. The clients or applications installed on the devices in conjunction with other aspects of the system provide for payment card and consumer based multi-factor authentication using serialized hologram tags with embedded data. The present systems and methods may include multi-dimensional encoding in three or more dimensions, tamper-proof (tamper-evident) tags on each secured item or ID, tamper-proof (self-destruct) scanners and web-based multi-national access.

In an embodiment, a user requests and/or receives a new or replacement credit or debit card. The card may contain a readable holographic image or the image may be presented on a separate media such as a hologram card, or as a simple hologram on any type of material or backing. Upon approval of the payment card, a user account is established and information regarding the user and the account is stored in a first database. In one or more embodiments, the holographic image or data associated with the holographic image is stored in a second database. In some embodiments, the second database is the same as the first database. In other embodiments, the second database is different than the first database. In some embodiments, the holographic image or data associated with the holographic image is associated with the user or information relating to the user. In other embodiments, the holographic image or data associated with the holographic image is associated with a code associated with the user or information relating to the user. In some embodiments, for example, the code may be a hash value or a value generated by a hash code generator or random number generator. Upon receipt of the new card and hologram, the user is invited to download an app or client to a smart device such as a tablet, smart phone or wearable device. Once the app or client is installed on the user's device, the user is prompted to establish an account. In some embodiments, the user is prompted to enter information verifying that the recipient of the new card or hologram is the user to whom such card or hologram was to be issued. In addition to the standard information, i.e., name, address, account name, password, email address, and other information regarding the user commonly used to open payment card or bank accounts, information unique to the user's device is collected and stored in a user database. The unique device information may be a unique device serial number, device ID number, or any other identifier unique to the device itself. The device ID may be a hardwired device ID, a read only memory location, a one time programmable memory location, or any other identification method. Once the user account is established or the information entered by the user is verified, or confirmed as matching the previously entered user information, the user is prompted to scan, photograph or otherwise capture the image of the hologram using the smart device. The image capture process may be repeated several times to ensure that the hologram image is correctly captured and stored both locally on the device as well as with the other user information in the first database, separate from the user information in the first database, or in a second database or other storage location. The captured image is transmitted along with the other user information or transmitted separately to the first database or the second database. Upon receipt of the holographic image at the user database, the image is authenticated with the previously stored images.

Once the account is established or verified and the hologram image captured, the user is able to use the card to make purchases from a vendor. To initiate a purchase from a vendor utilizing the authentication process of the present system, the user selects the authentication mode from the vendor's on-line site. The user is then provided with a multi-digit transaction code. This transaction code may be generated by the vendor, a remote computer or server, a local computer or server, or a computer or server associated with the authentication system. The user is then asked to input the transaction code via the app or client. Once the transaction code is input, the app or client transmits the transaction code and one or more images of the hologram to the system server. The system confirms the association between the user and the smart device. In some embodiments, the system confirms the association between the user and the hologram image. In some embodiments, the system confirms the association between the smart device and the hologram image. In some embodiments, the system implements one or more than one of the preceding actions. For example, the system confirms that the holographic image is associated with the user and the user's device and confirms the device ID number as well as the hologram image. The transaction code is also sent by the vendor, the remote computer or server, the local computer or server, or the computer or server associated with the authentication system to the system to confirm the transaction for which the user information is being authenticated. If the information authenticates, the user is provided with a second code, i.e., a verification code, via the user's smart device. The user then enters the verification code on the vendor site or provides the verification code to the vendor. In some embodiments, the vendor is provide with the verification code, which the vendor compares to the user provided verification code to confirm that the transaction may be completed. In some embodiments, the verification code may be sent by the vendor site or by the user to a remote computer or server, a local computer or server, or a computer or server associated with the authentication system where it may be compared to the system generated verification code. In some embodiments, the verification code may be provided by the system to the vendor for confirming authentication of the user's payment card. In some embodiments, upon authentication, the system sends the vendor a confirmation code corresponding to the transaction code.

In certain embodiments, there is no verification code provided to the user or vendor. In such embodiments, after verification that one or more of the holographic images is associated with the user and/or the user's device and/or confirms the device ID number and/or the hologram image, the system sends the vendor a confirmation message, flag, or token that indicates the verification of the authentication of the user's device and hologram, and the user's association with such item or items, thereby confirming that the vendor may proceed with the transaction. Upon receipt of such confirmation, the vendor may authorize the transaction with no further input required by the customer. In other embodiments, there is no confirmation message, flag, or token sent to the vendor, but instead, the system completes the processing of the transaction using payment card information or other payment options, such as, for example, bank account, gift account, other account, bit coin, block and chain, and/or other payment method associated with the user, the hologram, and/or the mobile device. Upon successful completion of the payment process, a message, flag, and/or token is sent to the vendor and/or customer. Thereupon, the vendor or system or both may provide the customer with a transaction number or some other form of confirmation of the transaction. This confirmation may be provided electronically, via the downloadable application, via SMS or email, via a web browser, or via other electronic means of communication, or in hard copy, or any combinations of the foregoing.

In some embodiments, the transaction information is displayed for the user to allow the user to visually or aurally confirm the transaction information when entering and proceeding with the transaction authentication. The transaction information and the authentication information is conveyed to a transaction database which authorizes and records the transaction. In this manner, a user must possess both the correct user device associated with that user as well as the hologram image associated with that user and/or device in order for a transaction to be completed. In some embodiments, the user must also enter the correct transaction code. If an unauthorized user attempts to use the hologram without the device or vice versa, the transaction will not succeeded and will not be processed.

In some embodiments, rather than transmitting a previously captured image of the hologram, the user may be asked to rescan the hologram or take another image of the hologram to complete the transaction or the authentication or verification. This may be particularly important for large value transactions, including on-line transactions. This may also be important for authentication sessions where the holder of the hologram or ID or the holder's presence is being authenticated, authorized, validated, and/or confirmed. This is important for systems or situations where the presence of personnel at a particular location is being confirmed, or verified, or where a transaction is being verified based on location or user identity.

In another embodiment, if the user fails to provide correct information to verify the account, such as a password, the user may be prompted to verify their ID by re-capturing the hologram image. In this way, the system ensures, that the person attempting to access the account is also in possession of the original hologram card or hologram ID.

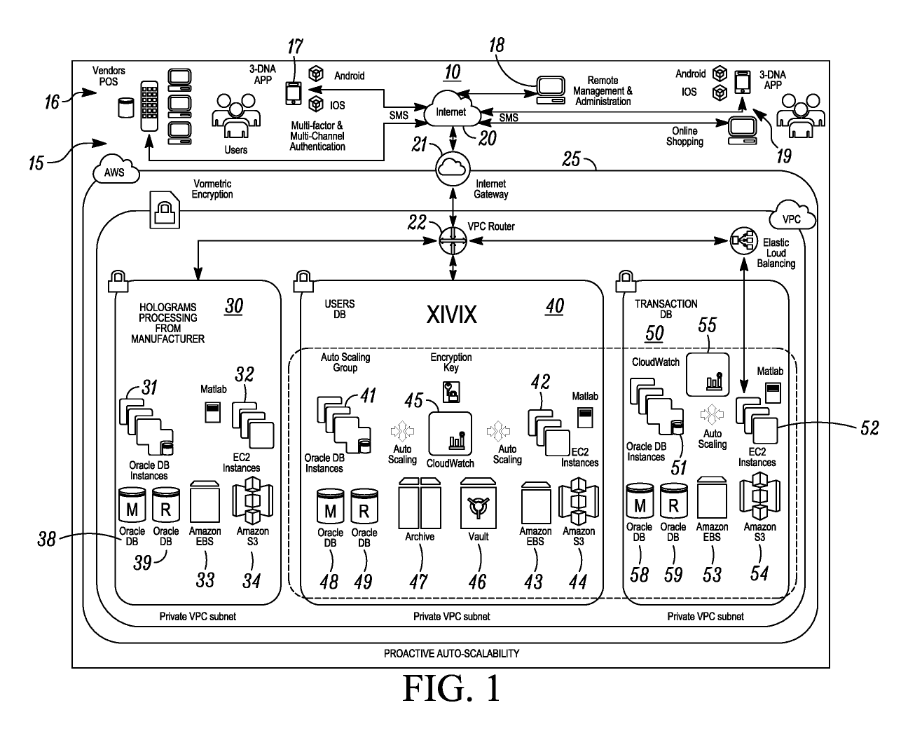

FIG. 1 is a schematic representation of a system 10 embodying the present disclosure. System 10 may be divided into a front end portion 15 and a back end portion 25. Front end portion 15 of system 10 comprises a vendor point of sale device 16, a mobile device 17, a remote management and administration terminal 18, an on-line shopping terminals 19 and a network 20. Vendor point of sales devices 16 may be vendor sales terminals, hand held devices such as a mobile device utilizing a card reader, a tablet, a kiosk, or any other network coupled device used to capture payment card information and finalize a transaction. Mobile device 16 may include any form of smart device, such as a smart phone, tablet, wearable, such as a smart watch, PDA, laptop, or any other wired or wireless device capable of communicating over a local network or a wide area network such as the internet. Mobile device 17 may include an application specifically installed or downloaded to be used in the system and methods of the present disclosure. Mobile device 17 may communicate using various wired and or wireless technologies, including CDMA, TDMA, GSM, WiFi, 3G, 4G, and may have any type of operating system such as iOS, Android, Windows, Linux, etc. Mobile devices 17 may utilize any form of data transmission and may enable user communications via SMS, voice, data, e-mail, instant messaging, or any other wired or wireless communications.

Remote management and administrative terminal 18 may be any computer, server, network or sub-network with an interface device that allows an administrator to access the network and underlying data and databases of the present disclosure. Remote management and administrative terminal 18 may be located with other portions of the system or may be remotely located. Remote management and administrative terminal 18 may be capable of communicating over a wide area network such as the internet or any other local area networks. Remote management and administrative terminal 18 may be a computer, a server, a tablet, a dumb terminal or any other device for communicating over a network. On line shopping terminal 19, may be a general purpose or dedicated computer, tablet, or smart device. It may be located at a user's location, in a public area, in a home, in a kiosk, or in any other area where a user might have access to such a terminal.

Network 20 may be a local area network or a wide area network such as the internet. It may be an open network available for any user to access or a closed area network limited to authorized users only. Network 20 may be implemented as a wired, wireless, or combination of the two. Network 20 may be capable of transmitting, data, voice, or SMS information and messages.

Back end portion 25 comprises hologram processing portion 30, user data portion 40 and a transaction portion 50. Back end portion 25 is coupled to front end portion 15 via an internet gateway 21. Internet gateway 21 may be a gateway or node that serves as an access point to another network to or from the Internet. Internet gateway 21 may be a horizontally scaled, redundant, and highly available Virtual Private Cloud (VPC) component that allows communication between instances in a VPC and the Internet. It may be provided by an internet service provider or may be a public gateway. It may be any node that routes traffic from a user terminal, workstation, server, or other computing device to another network segment.

Internet gateway 21 may be coupled to a VPC router 22. VPC router 22 enables a software-defined network (SDN) optimized for moving large amounts of packets into, out of and across networks. VPC router 22 may transmit information to, or receive information from hologram processing portion 30, user data portion 40 and a transaction portion 50. In addition to VPC router 22, each of the hologram processing portion 30, user data portion 40 and a transaction portion 50 may have a separate VPC router associated with it (22a-c) not shown. Like VPC router 22, routers 22a-c each communicate information from and to the respective hologram processing portion 30, user data portion 40 and transaction portion 50 of the present disclosure.

Hologram processing portion 30 comprises one or more instances of an oracle database 31 (this can be any other type of database, for example, a SQL database), one or more elastic compute cloud (EC2) instances 32, elastic block storage (EBS) devices 33, simple storage services (S3) 34 and any other storage and or database components necessary to process and maintain the hologram database. Hologram processing portion 30 also comprises a main data base 38 and a redundant database 39. Hologram processing portion 30 is coupled to VPC router via a private VPC subnet and may communicate direct to/from the users, hologram manufacturers, vendors or merchants as well as with the user DB 40 and transaction DB 50. Oracle database instances 31 may be used to scale the hologram processing portion 30 when oracle DB 38 and redundant DB 39 are run maximized. The instances 31 allow for scaling and expansion of the platform using third party web based services. Elastic compute cloud or EC2 instances 32 allows the service provider to use virtual computers on which to run the system of the present disclosure. EC2 instances 32 allows scalable deployment of applications by providing a Web service through which a service provider can boot a machine image to create a virtual machine, often referred to as an “instance”. The instance contains any software desired by the service provider. In this manner, the service provider can create, launch, and terminate server instances as needed, paying by the hour for active servers. EC2 provides service providers with control over the geographical location of instances that allows for latency optimization and high levels of redundancy.

Elastic block storage (EBS) devices 33 provides raw block devices that can be attached to the EC2 instances 32. These block devices can be used like any raw block device. In a typical use case, this includes formatting the device with a file system and mounting said files system. In addition EBS devices 33 supports a number of advanced storage features, including snapshotting and cloning. EBS devices 33 may be built on and replicated as back end storage, so that the failure of a single component will not cause data loss.

Simple storage service 34 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key. EC2 instances 32, EBS devices 33 and S3 34 may be provided by a service provider such as Amazon™ Web services or by any other online web service provider.

Hologram processing portion 30 may be used to store the hologram identification information for each user card and/or hologram card manufactured. In addition to storing the actual hologram image, data associated with the hologram may also be stored in the Oracle DB instances 31. This information may be a unique alphanumeric ID, a descriptive term or any other identifier. The information in hologram processing portion 30 may be communicated to user data portion 40, and transaction portion 50 via VPC router 22. Upon activation of a card by a user, the associated hologram information from hologram portion 30 is conveyed to and stored in user portion 40 in the record associated with the respective user. Alternatively, the hologram information is stored in a secure database segregated from the user portion and is only associated with the user information through an identifier that excludes personally identifiable information of the user.

Alternatively, in certain embodiments in place of hologram information and in place of using a hologram, the system uses a hash code that is transmitted by the mobile device or other user device to the system. This hash code may be input using a dongle or plug in device that plugs into the mobile device or user device. In all other manners the system operates just as the hologram based system. However, in place of an image analysis, a hash code analysis is performed to authenticate the hash code and ensure it is associated with the user device and the user.

Alternatively, in certain embodiments in place of hologram information and in place of using a hologram, the system uses an audio file generated by the user at the time of the transaction using the mobile device or some other device and is transmitted by the mobile device or other user device to the system. This audio may alternatively be input using a dongle or plug in device that plugs into the mobile device or user device. In all other manners the system operates just as the hologram based system. However, in place of an image analysis an audio analysis is performed to authenticate the audio file and ensure it is associated with the user device and the user. The audio file may be a statement or a number of words spoken by the user. These can include prerecorded phrases or words that are stored by the system, and then matched to the same words or phrases spoken by the user at the time of authentication or pre-stored on a dongle, plug in device or in an encrypted file on the mobile device or other user device.

User data portion 40 is coupled to VPC router through a second VPC subnet (not shown). User data portion 40 may communicate with the internet via internet gateway 21 and may also communicate with hologram processing portion 30, and transaction portion 50. User data portion 40 comprises oracle DB instances 41, EC2 instances 42, EBS devices 43, simple storage service 44, cloud watch 45, a data vault 46, a data archive 47, oracle main database 48 and oracle redundant DB 49 (any databases, for example SQL, in place of the oracle databases). Main database 48 and redundant database 49 are primarily used for managing and maintaining all user information, including, but not limited to name, user name, address, password, e-mail account, device ID, and hologram information. Alternatively, the hologram information may be stored in a secure database segregated from the user portion and is only associated with the user information through an identifier, for example, a hash code or random number, that excludes personally identifiable information of the user. When the system of the present disclosure is scaled, oracle DB instances 41 may be utilized to manage the data for the extra capacity without having to physically install and manage the associated hardware. EC2 instances 42 allows scalable deployment of applications by providing a Web service through which a service provider can boot a machine image to create a virtual machine, often referred to as an “instance”.

Elastic block storage (EBS) devices 43 provides raw block devices that can be attached to the EC2 instances 42. These block devices can be used like any raw block device. In a typical use case, this includes formatting the device with a file system and mounting said files system. In addition EBS devices 43 supports a number of advanced storage features, including snapshotting and cloning. EBS devices 43 may be built on and replicated as back end storage, so that the failure of a single component will not cause data loss.

Simple storage service 44 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key.

Cloudwatch 45 is a monitoring service for cloud resources and the applications run on the backend 25. Cloudwatch 45 collects and track metrics, collects and monitors log files, and set alarms. CloudWatch 45 monitors resources such EC2 instances, dynamo tables, and RDS DB instances, as well as custom metrics generated by applications and services, and any log files the applications generate. CloudWatch 45 may be used to gain system-wide visibility into resource utilization, application performance, and operational health. Vault 46 may be a secure storage location for maintaining customer account information that requires additional security. This may include credit card information, government ID information, passwords, and other related information. Archive 47 may be a data archive to store inactive user information, transaction data, data of a specific age or type. The use of archive 47 alleviates some of the congestion that might occur if databases 48 and 49 are not maintained at a manageable size limit.

EC2 instances 42, EBS devices 43, S3 (44), cloud watch 45 may be provided by a service provider such as Amazon™ Web services or by any other online web service provider.

Transaction database portion 50 is coupled to VPC router through a VPC subnet (not shown). Transaction database portion 50 may communicate with the internet via internet gateway 21 and may also communicate with hologram processing portion 30, and user portion 40. Transaction database portion 50 comprises oracle DB instances 51, EC2 instances 52, EBS devices 53, simple storage service 54, CloudWatch 55, oracle main DB 58 and oracle redundant DB 59. Main database 58 and redundant database 59 are primarily used for managing and maintaining user transaction data. Oracle DB instances 51, EC2 instances 52 may be used for scalability as the number of users and transactions increase the use of virtual resources becomes critical to maintaining functionality.

When the system of the present disclosure is scaled, oracle DB instances 51 may be utilized to manage the data for the extra capacity without having to physically install and manage the associated hardware. EC2 instances 52 allows scalable deployment of applications by providing a Web service through which a service provider can boot a machine image to create a virtual machine, often referred to as an “instance”.

The Elastic block storage (EBS) devices 53 of transaction database portion 50 provides raw block devices that can be attached to the EC2 instances 52. These block devices can be used like any raw block device. In a typical use case, this includes formatting the device with a file system and mounting said files system. In addition EBS devices 53 supports a number of advanced storage features, including snapshotting and cloning. EBS devices 53 may be built on and replicated as back end storage, so that the failure of a single component will not cause data loss.

Simple storage service 54 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key.

Cloudwatch 55 is a monitoring service for cloud resources and the applications run on the backend 25. Cloudwatch 55 collects and track metrics, collects and monitors log files, and set alarms. CloudWatch 55 monitors resources such EC2 instances, dynamo tables, and RDS DB instances, as well as custom metrics generated by applications and services, and any log files the applications generate. CloudWatch 55 may be used to gain system-wide visibility into resource utilization, application performance, and operational health.

EC2 instances 52, EBS devices 53, S3 (54), CloudWatch 55 may be provided by a service provider such as Amazon™ Web services or by any other online web service provider. It is to be understood that one or all of these portions 30, 40 and 50 may be implemented in a single machine, on a single server or on a distributed architecture across numerous machines, servers, processors located in one or more locations. A computer, server, VPN, may perform all the steps or a portion of the steps and may store all or part of the data.

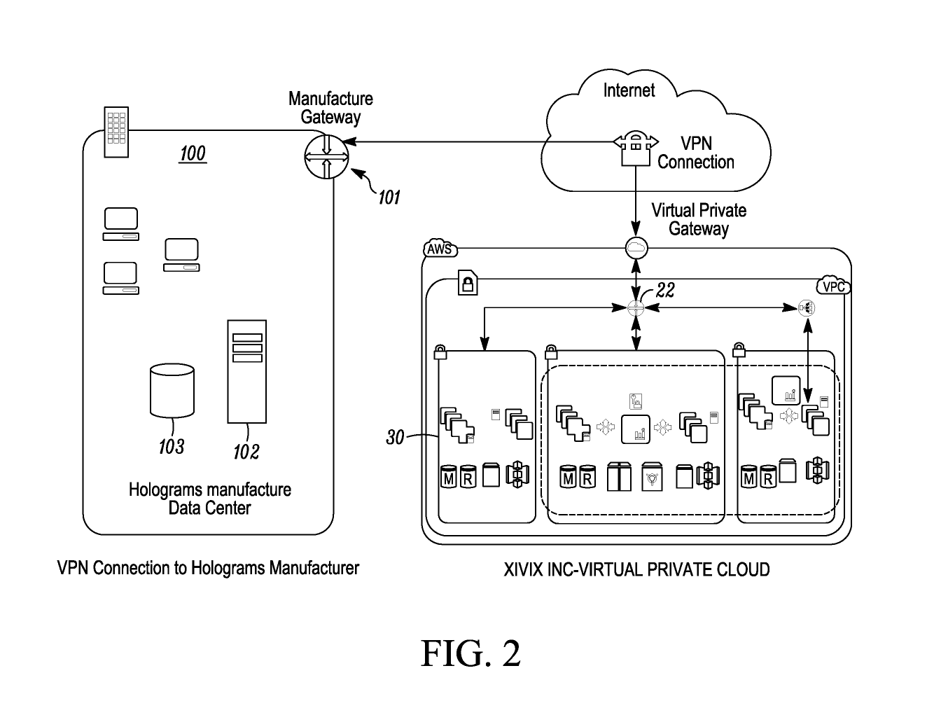

FIG. 2 is a drawing depicting the interconnections between the hologram manufacturer data center and system 10. The hologram manufacturer 100 may manufacture the holographic images and imprint them on cards, imprint them on materials that are bonded to, coupled to, laminated with, or embedded within the cards, or generate the holograms in any known manner. Manufacturer 100 may capture images from the holograms and convey that information to system 10 via a network such as the internet. Manufacturer 100 conveys the holographic information via manufacturers gateway 101 to the virtual private cloud of the authentication provider via a VPN connection coupled to VPC router 22. The manufacturer 100 may store the hologram images and all the associated data on servers 102 and in database 103. Upon connecting with System 10 via VPC router 22, the hologram images and associated information may be conveyed to holographic processing portion 30 for storage. Once the hologram image information associated with a card, user, and/or mobile device or other user device is stored, it may be used later on to compare the hologram image information received from a user when the user is activating a purchase card or authenticating a transaction. Alternatively, the hologram image information may be stored in a dedicated secure database to be used later for image comparison purposes.

In place of the hologram images and the hologram image information, one or more hash codes and hash code information associated with the user, a user dongle, a user storage device, and/or mobile device or other user device is stored, it may be used later on to compare the hash code information received from a user when the user is activating a purchase card or authenticating a transaction. Alternatively, the hash code information may be stored in a dedicated secure database to be used later for hash code comparison purposes.

In place of the hologram images and the hologram image information, one or more audio files and audio file information associated with the user, a user dongle, a user storage device, and/or mobile device or other user device is stored, it may be used later on to compare the audio file information received from a user when the user is activating a purchase card or authenticating a transaction. Alternatively, the audio file information may be stored in a dedicated secure database to be used later for audio file comparison purposes.

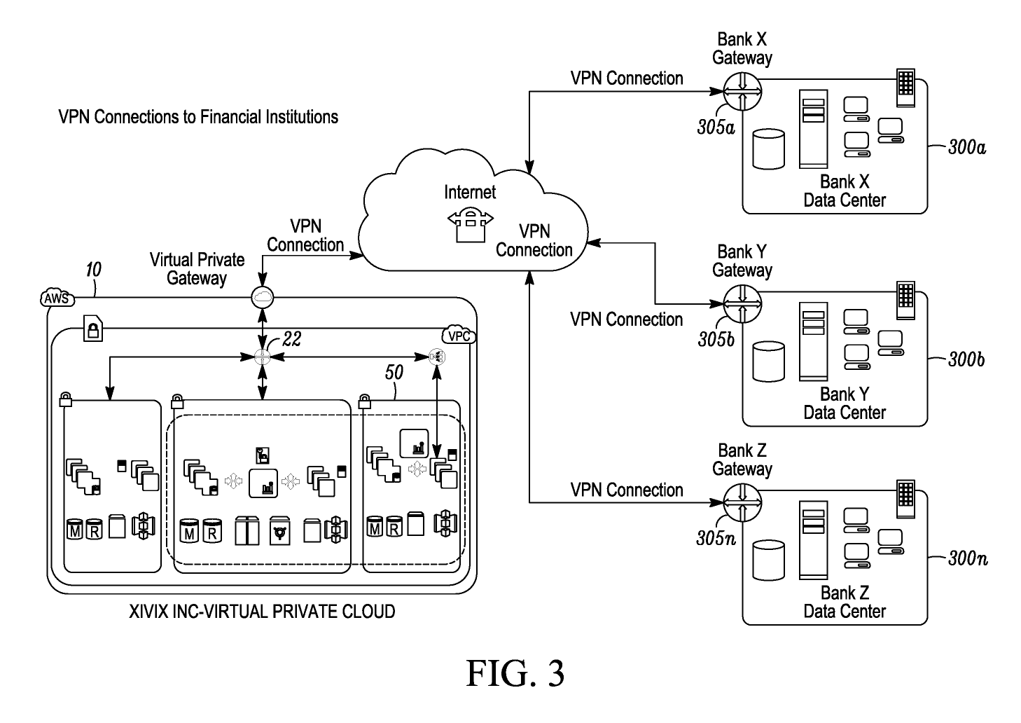

FIG. 3 is a drawing depicting the interconnections between the authentication system 10 and financial institutions. Financial institutions 300a-300n may be banks, credit card issuers, debit card issuers, investment firms or any other institution that issues credit or debit cards or that manage or assist with payment card processing and/or fulfillment. Financial institutions 300a-300n may all have their own secure network gateways 305a-305n, which allow them to communicate across a network, such as the internet. The financial institutions 300a-300n may establish virtual private network connections over the internet to communicate directly with the VPC router 22 or system 10. Once a connection is established, the financial institutions may communicate directly with transaction portion of system 10. Communications between financial institutions and system 10 may include information related to the user transaction, such as total purchase time, date, currency, location vendor information, and all other transaction information. The financial institutions 300a-300n may also convey information to system 10 such as invalid card number, stolen card, card exceeds credit limit, unauthorized purchase type, exceeds daily purchase limit, and all other information obtained, derived or determined by the financial institutions, including relating to the user, user's account, payment card or the transaction. Any communications between transaction portion 50 and financial institutions 300a-n occur over the VPN ensuring that only the financial institutions and the system 10 have access to the information.

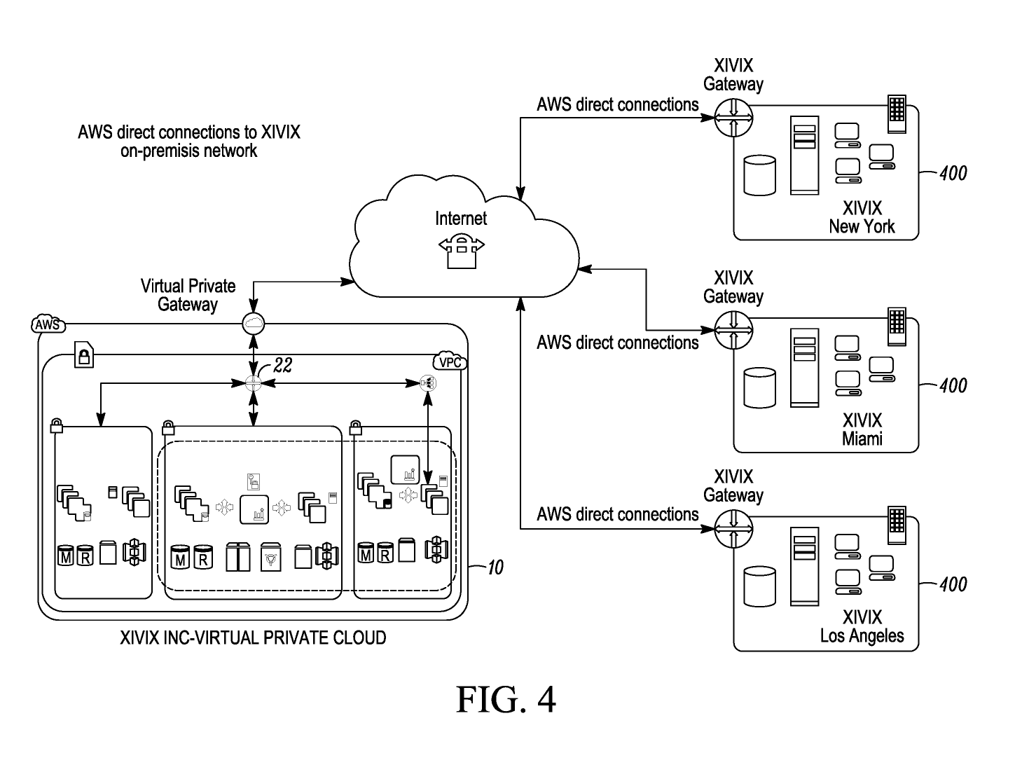

FIG. 4 depicts the distributed nature of an authentication system in accordance with an embodiment of the present disclosure. As depicted system 10 via VPC router 22 may communicate over a wide area network such as the internet to numerous instances of the authentication gateway. These distributed gateways 400 may be geographically distributed to allow for security, redundancy, enhanced speed, enhanced reliability. As depicted all connections between system 10 and the distributed gateways 400 occurs via virtual web service direct connections. It will be understood that the system may be distributed in three locations as depicted or in any number of locations. Distribution may be temporal, i.e., in different time zones, geographic, or by cost of operations and availability of data capacity. The distributed nature of the system allows for scalability, reliability, redundancy and cost savings.

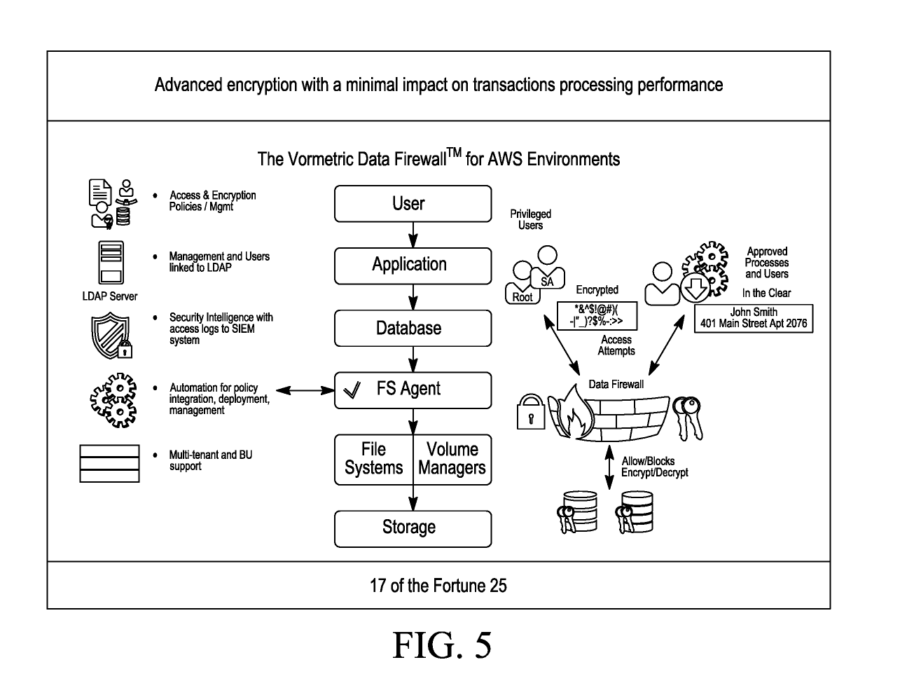

FIG. 5 depicts a layer of advanced encryption data protection for web services environments. In an embodiment, a data firewall is implemented to secure the transaction data and user data in a secure fashion despite the fact that is resident on a cloud environment. In an embodiment, a Vormetric data firewall from Vormetric Inc. was used. The data firewall may use tokenized data, for privileged users and open data for approved processes and users. The firewall may reside between the database and the storage thereby ensuring that the data stored in the cloud space is protected from unauthorized users.

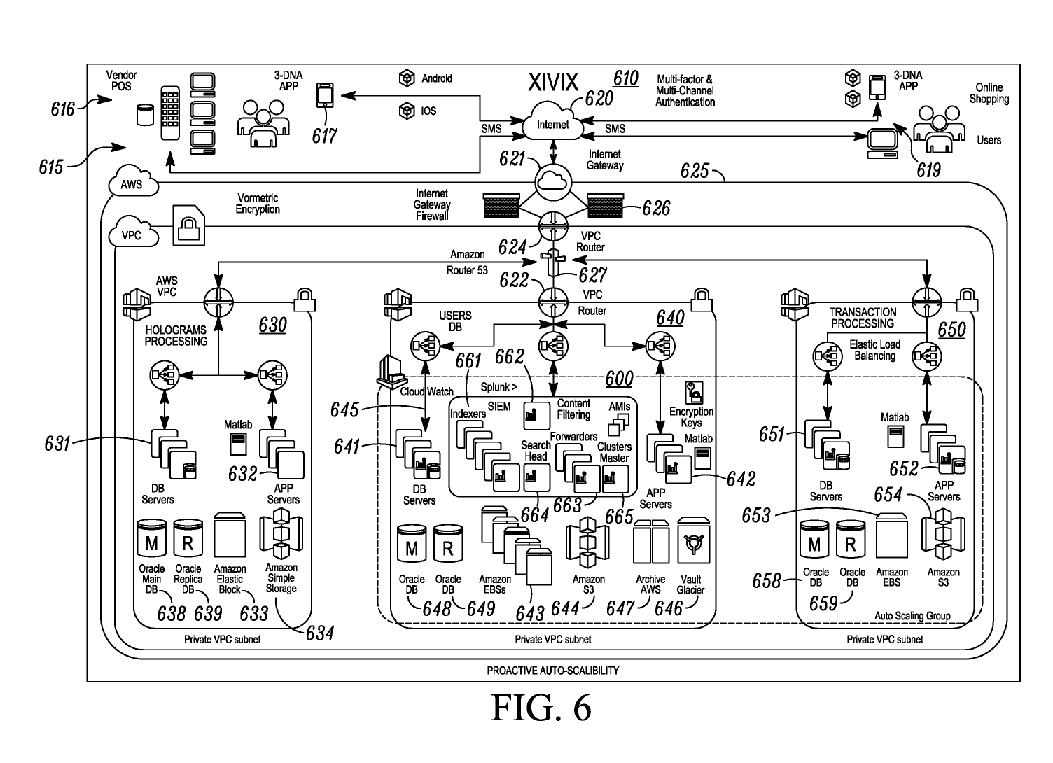

FIG. 6 depicts an alternative embodiment for the present disclosure. FIG. 6 is a schematic representation of system 610 embodying an alternative system configuration of the present disclosure including a security information and event management (SIEM) system. A SIEM provides for real-time analysis of security alerts and data analytics generated by network hardware and applications.

System 610 may be divided into a front end portion 615 and a back end portion 625. Front end portion 615 of system 610 comprises a vendor point of sale device 616, a mobile device 617, an on-line shopping terminal 619 and a network 620. Vendor point of sales devices 616 may be vendor sales terminals, hand held devices such as a mobile device utilizing a card reader, a tablet, a kiosk, or any other network coupled device used to capture payment card information and finalize a transaction. Mobile device 616 may include any form of smart device, such as a smart phone, tablet, wearable, such as a smart watch, PDA, laptop, or any other wired or wireless device capable of communicating over a local network or a wide area network such as the internet. Mobile device 617 may include an application specifically implanted to be used in the system and methods of the present disclosure. Mobile device 617 may communicate using various wired and or wireless technologies, including CDMA, TDMA, GSM, WiFi, 3G, 4G, and may have any type of operating system such as iOS, Android, Windows, etc. Mobile devices 617 may utilize any form of data transmission and may enable user communications via SMS, voice, data, e-mail, instant messaging, or any other wired or wireless communications.

A remote management and administrative terminal (not shown) may be any computer, server, network or sub-network with an interface device that allows an administrator to access the network and underlying data and databases of the present disclosure. The remote management and administrative terminal may be located with other portions of the system or may be remotely located. The remote management and administrative terminal may be capable of communicating over a wide area network such as the internet or any other local area networks. The remote management and administrative terminal may be a computer, a server, a tablet, a dumb terminal or any other device for communicating over a network. On line shopping terminal 619, may be a general purpose or dedicated computer, tablet, or smart device. It may be located at a user's location, in a public area, in a home, in a kiosk, or in any other area where a user might have access to such a terminal.

Network 620 may be a local area network or a wide area network such as the internet. It may be an open network available for any user to access or a closed area network limited to authorized users only. Network 620 may be implemented as a wired, wireless, or combination of the two. Network 620 may be capable of transmitting, data, voice, or SMS information and messages.

Back end portion 625 comprises hologram processing portion 630, user data portion 640, and transaction portion 650 which further comprises Security Information and Event Management (SIEM) portion 660. Back end portion 625 is coupled to front end portion 615 via an internet gateway 621. Internet gateway 621 may be a gateway or node that serves as an access point to another network to or from the Internet. Internet gateway 621 may be a horizontally scaled, redundant, and highly available Virtual Private Cloud (VPC) component that allows communication between instances in a VPC and the Internet. It may be provided by an internet service provider or may be a public gateway. It may be any node that routes traffic from a user terminal, workstation, server, or other computing device to another network segment.

Internet gateway 621 may be coupled to a VPC router 625 which routs data to backend portion 625. Internet gateway 621 may be coupled to router 625 via an internet firewall 626. Firewall 626 may be any known firewall that prevents, and detects incoming and outgoing data from unwanted or intrusive data. VPC router 625 may be connected to a scalable Domain Name System web service 627 such as an Amazon Router 53. The DNS should be highly available and scalable cloud web service designed to provide extremely reliable and cost effective way to route end users to Internet applications by translating names domain names into the numeric IP addresses. In an embodiment, the Domain Name System web service 627 is an Amazon Route 53 that effectively connects user requests to infrastructure running in AWS—such as Amazon EC2 instances, Elastic Load Balancing load balancers, or Amazon S3 buckets—and can also be used to route users to infrastructure outside of AWS. The Domain Name System web service 627 makes it possible to manage traffic globally through a variety of routing types, including Latency Based Routing, Geo DNS, and Weighted Round Robin—all of which can be combined with DNS Failover in order to enable a variety of low-latency, fault-tolerant architectures.

VPC router 622 enables a software-defined network (SDN) optimized for moving large amounts of packets into, out of and across networks. VPC router 622 may transmit information to, or receive information from hologram processing portion 630, user data portion 640 and a transaction portion 650. In addition to VPC router 622, each of the hologram processing portion 630, user data portion 640 and a transaction portion 650 may have a separate VPC router associated with it (622a-c) not shown. Like VPC router 622, routers 622a-c each communicate information from and to the respective hologram processing portion 630, user data portion 640 and transaction portion 650 of the present disclosure.

Hologram processing portion 630 comprises one or more instances of a DB Server 631 (this can be any other type of database, for example, a SQL database), one or more App Servers 632, elastic block storage (EBS) devices 633, simple storage services (S3) 634 and any other storage and or database components necessary to process and maintain the hologram database. Hologram processing portion 630 also comprises a main data base 638 and a redundant database 639. Hologram processing portion 630 is coupled to VPC router via a private VPC subnet and may communicate direct to/from the users, hologram manufacturers, vendors or merchants as well as with the user DB 640 and transaction DB 650. DB Servers 631 may be used to scale the hologram processing portion 630 when oracle DB 638 and redundant DB 639 are run maximized. The DB Servers 631 allow for scaling and expansion of the platform using third party web based services. App Servers 632 allows the service provider to use virtual computers on which to run the system of the present disclosure. App Servers 632 allows scalable deployment of applications by providing a Web service through which a service provider can boot a machine image to create a virtual machine, often referred to as an “instance”. The instance contains any software desired by the service provider. In this manner, the service provider can create, launch, and terminate server instances as needed, paying by the hour for active servers. App Servers provides service providers with control over the geographical location of instances that allows for latency optimization and high levels of redundancy.

Elastic block storage (EBS) devices 633 provides raw block devices that can be attached to the App Servers 632. These block devices can be used like any raw block device. In a typical use case, this includes formatting the device with a file system and mounting said files system. In addition EBS devices 633 supports a number of advanced storage features, including snapshotting and cloning. EBS devices 633 may be built on and replicated as back end storage, so that the failure of a single component will not cause data loss.

Simple storage service 634 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key. App Server 632, EBS devices 633 and S3 634 may be provided by a service provider such as Amazon™ Web services or by any other online web service provider.

Hologram processing portion 630 may be used to store the hologram identification information for each user card and/or hologram card manufactured. In addition to storing the actual hologram image, data associated with the hologram may also be stored in the DB Servers 631. This information may be a unique alphanumeric ID, a descriptive term or any other identifier. The information in hologram processing portion 630 may be communicated to user data portion 640, and transaction portion 650 via VPC router 622. Upon activation of a card by a user, the associated hologram information from hologram portion 630 is conveyed to and stored in user portion 640 in the record associated with the respective user. Alternatively, the hologram information is stored in a secure database segregated from the user portion and is only associated with the user information through an identifier that excludes personally identifiable information of the user.

User data portion 640 is coupled to VPC router through a second VPC subnet (not shown). User data portion 640 may communicate with the internet via internet gateway 621, firewall 626, and DNS web service 627 and may also communicate with hologram processing portion 630, and transaction portion 650. User data portion 640 comprises oracle DB servers 641, App servers 642, EBS devices 643, simple storage service 644, cloud watch 645, a data vault 646, a data archive 647, oracle main database 648 and oracle redundant DB 649 (any databases, for example SQL, in place of the oracle databases). User data portion 40 also comprises A security intelligence platform (SIEM) 600. In an embodiment, SIEM 600 was a SPLUNK platform. SIEM 600 comprises Indexer 661, content filtering 662, forwarders 663, search head 664 and cluster master 665.

Main database 648 and redundant database 649 are primarily used for managing and maintaining all user information, including, but not limited to name, user name, address, password, e-mail account, device ID, and hologram information. Alternatively, the hologram information may be stored in a secure database segregated from the user portion and is only associated with the user information through an identifier, for example, a hash code or random number, that excludes personally identifiable information of the user. When the system of the present disclosure is scaled, DB servers 641 may be utilized to manage the data for the extra capacity without having to physically install and manage the associated hardware. App Servers 642 allows scalable deployment of applications by providing a Web service through which a service provider can boot a machine image to create a virtual machine, often referred to as an “instance”.

Elastic block storage (EBS) devices 643 provides raw block devices that can be attached to the App Servers 642. These block devices can be used like any raw block device. In a typical use case, this includes formatting the device with a file system and mounting said files system. In addition EBS devices 643 supports a number of advanced storage features, including snapshotting and cloning. EBS devices 643 may be built on and replicated as back end storage, so that the failure of a single component will not cause data loss.

Simple storage service 644 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key.

Cloudwatch 645 is a monitoring service for cloud resources and the applications run on the backend 625. Cloudwatch 645 collects and track metrics, collects and monitors log files, and set alarms. CloudWatch 45 monitors resources such EC2 instances, dynamo tables, and RDS DB instances, as well as custom metrics generated by applications and services, and any log files the applications generate. CloudWatch 645 may be used to gain system-wide visibility into resource utilization, application performance, and operational health. Vault 646 may be a secure storage location for maintaining customer account information that requires additional security. This may include credit card information, government ID information, passwords, and other related information. Archive 647 may be a data archive to store inactive user information, transaction data, data of a specific age or type. The use of archive 647 alleviates some of the congestion that might occur if databases 648 and 649 are not maintained at a manageable size limit.

App Servers 642, EBS devices 643, S3 (44), cloud watch 645 may be provided by a service provider such as Amazon™ Web services or by any other online web service provider.

Transaction database portion 650 is coupled to VPC router through a VPC subnet (not shown). Transaction database portion 650 may communicate with the internet via internet gateway 621 and may also communicate with hologram processing portion 630, and user portion 640. Transaction database portion 650 comprises DB servers 651, App servers 652, EBS devices 653, simple storage service 654, oracle main DB 658 and oracle redundant 6DB 59. Main database 658 and redundant database 659 are primarily used for managing and maintaining user transaction data. DB Servers 651, App Servers 652 may be used for scalability as the number of users and transactions increase the use of virtual resources becomes critical to maintaining functionality.

When the system of the present disclosure is scaled, DB Servers 651 may be utilized to manage the data for the extra capacity without having to physically install and manage the associated hardware. App servers 652 allows scalable deployment of applications by providing a Web service through which a service provider can boot a machine image to create a virtual machine, often referred to as an “instance”.

The Elastic block storage (EBS) devices 653 of transaction database portion 650 provides raw block devices that can be attached to the App servers 652. These block devices can be used like any raw block device. In a typical use case, this includes formatting the device with a file system and mounting said files system. In addition EBS devices 653 supports a number of advanced storage features, including snapshotting and cloning. EBS devices 653 may be built on and replicated as back end storage, so that the failure of a single component will not cause data loss.

Simple storage service 654 provides storage through web services interfaces. S3 may store arbitrary objects and computer files up to 5 terabytes in size, each accompanied by up to 2 kilobytes of metadata. Objects may be organized into buckets and identified within each bucket by a unique, user-assigned key. App servers 652, EBS devices 653, S3 (654), may be provided by a service provider such as Amazon™ Web services or by any other online web service provider.

In an embodiment, SIEM 600 was a SPLUNK platform. In an embodiment SIEM 600 is implemented across both the user DB 640 and transaction portion 650. SIEM 600 may collect, monitor, log, parse, and analyze all incoming and outgoing data from user DB 640 and transaction portion 650. SIEM 600 provides real-time analysis of security alerts generated by network hardware and applications. SIEM 600 may be software, hardware or managed services, and may are be used to log security data and generate reports for compliance purposes. SIEM 600 may gather, analyze and present information from network and security devices; identity and access management applications; vulnerability management and policy compliance tools; operating system, database and application logs; and external threat data. A goal of SIEM 600 is to monitor and manage users and service privileges, directory services and other system configuration changes; as well as providing log auditing and review and incident response.

SIEM 600 may provide data aggregation to log management aggregates data from many sources, including network, security, servers, databases, applications, providing the ability to consolidate monitored data to help avoid missing crucial events. It may provide correlation and look for common attributes, and may link events together into meaningful bundles. SIEMs 600 may provide the ability to perform a variety of correlation techniques to integrate different sources, in order to turn data into useful information.

SIEM 600 may provide alerting functions for the automated analysis of correlated events and production of alerts, to notify recipients of immediate issues. Alerting can be to a dashboard, or sent via third party channels such as email, text, etc. SIEMS 600 may utilize dashboards or any other visual representation that can take event data and turn it into informational charts to assist in seeing patterns, or identifying activity that is not forming a standard pattern. SIEMs 600 can be employed to automate the gathering of compliance data, producing reports that adapt to existing security, governance and auditing processes and may be used for retention by employing long-term storage of historical data to facilitate correlation of data over time, and to provide the retention necessary for compliance requirements. Long term log data retention may be critical in forensic investigations. SIEMs 600 may provide the ability to search across logs on different nodes and time periods based on specific criteria.

SIEMs 600 comprises indexer 661, content filtering 662, forwarders 663, search head 664 and cluster master 665. Indexer 661 typically runs daemon service, that receives data and indexes based on a pre-defined Syntax. This data is then sent to a data store. Each data store has a set of indexes based on the amount of logs received. The data store can then be configured for retention, hot or cold or warm standby, or some other function. These are often referred to as slave nodes. Data that may be indexed includes logs, clickstream data, configurations, traps and alerts, messages, scripts, performance data and statistics from applications, servers, mainframes and network devices—physical, virtual and in the cloud.

Content filter 662 may capture incoming data to read incoming content and filter the content to determine behavior that may be malicious. A single log may not be enough information to recognize an attack vector but consolidating everything to a single event simplifies the understanding of what might be going on. Event focused SIEM solutions typically analyze data near real-time to alert high-level threats so action can be performed.

Forwarders 663 may reliably stream data from remote systems. Forwarders 663 can be deployed where the data you need isn't available over the network or visible to the server. Forwarders 663 may deliver reliable, secure, real-time universal data collection for tens of thousands of sources. It may monitor local application log files, clickstream data, the output of status commands, performance metrics from virtual or non-virtual sources, or watch the file system for configuration, permissions and attribute changes.

Search head 664 serves as the single console to search across all data stores and has a “summary index” to know which Indexer (slave) node to query and what index to query.

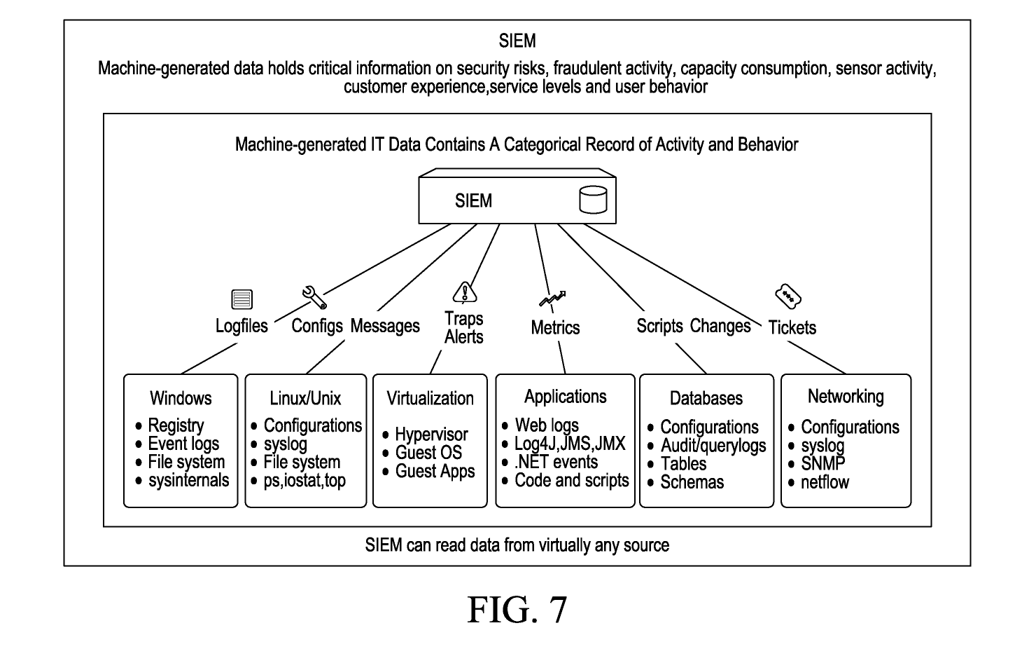

FIG. 7 depicts some of the capabilities and features of SIEM 600 in accordance with an embodiment of the present disclosure. These features include Windows functionality, including without limitation, registry, events logs, file system, and sysinternals. It also includes Linux/Unix functionality, including without limitation, configurations, syslog, file system, ps, iostat, and top. It includes Virtualization, including without limitation, Hypervisor, Guest OS, and Guest App. It also includes Applications, including without limitation, Web logs, Log4J, JMS, JMX, .NET events, Code and scripts. It also includes functionality relating to Databases, including without limitation, Configurations, Audit/query logs, Tables, and Schemas. It further includes Networking functionality, including without limitation, Configurations, syslog, SNMP, and netflow. The SIEMs 600 can read data from virtually any source. SIEM 600 provides for machine generated data that holds critical information on security risks, fraudulent activity, capacity consumption, sensor activity, customer experience, service levels and user behavior. Machine generated IT data contains a categorical record of activity and behavior.

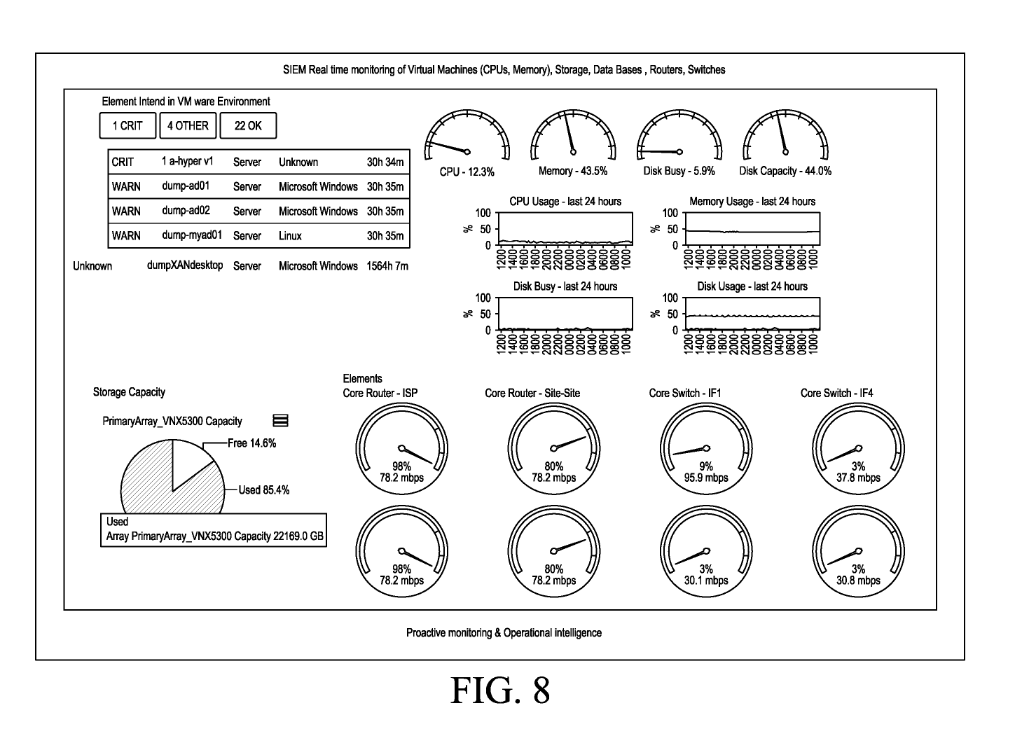

FIG. 8 depicts an exemplary dashboard and features of SIEM 600 in accordance with an embodiment of the present disclosure.

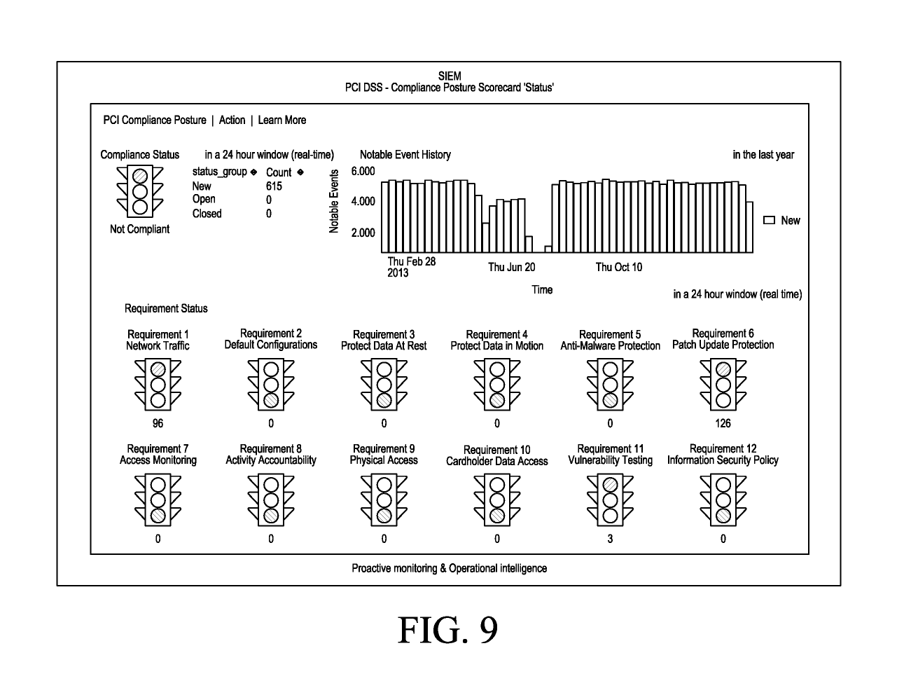

FIG. 9 depicts an exemplary alert and status display of SIEM 600 in accordance with an embodiment of the present disclosure.

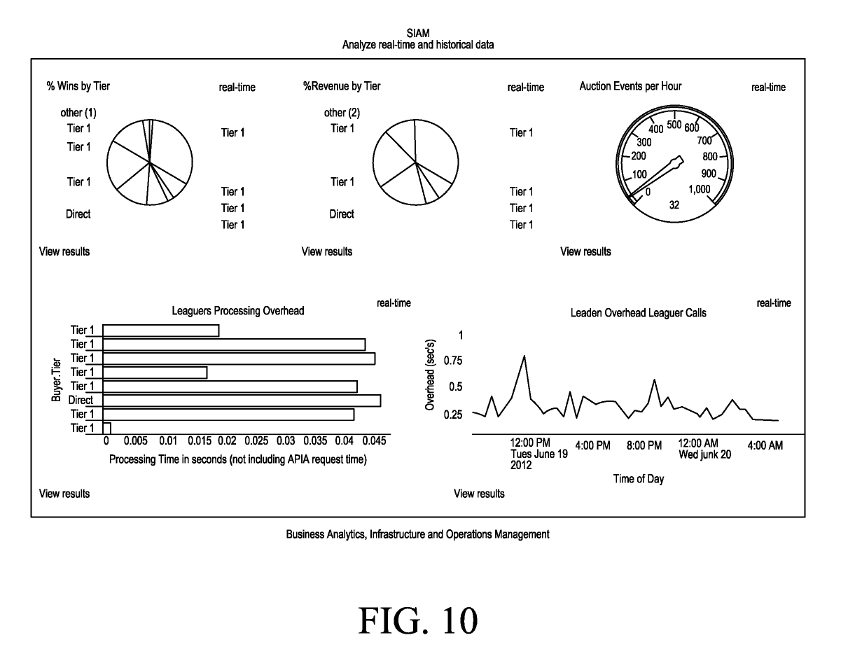

FIG. 10 depicts an exemplary analyses display of SIEM 600 in accordance with an embodiment of the present disclosure.

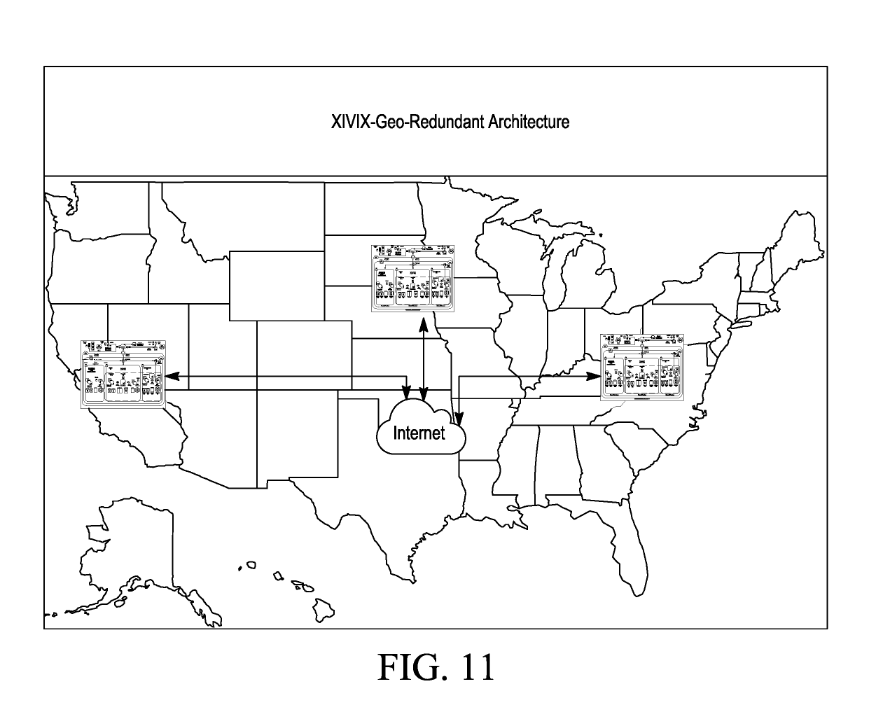

FIG. 11 depicts illustration of the geo-redundant architecture of the system in accordance with an embodiment of the present disclosure.

It is to be understood that one or all of these portions 30, 40, 50, 630, 640, 600 and 650 may be implemented in a single machine, on a single server or on a distributed architecture across numerous machines, servers, processors located in one or more locations. A computer, server, VPN, may perform all the steps or a portion of the steps and may store all or part of the data.

1. A system for authenticating a transaction, comprising:
a server, the server configured to:
receive a first transaction code from a smart device, the first transaction code corresponding to at least one pending transaction between a user and a merchant;
receive a second transaction code from the merchant, the second transaction code corresponding to the at least one pending transaction between the user and the merchant;
receive a smart device identifier, the identifier identifying the smart device, wherein the identifier corresponding to the user, a payment card, or both the user and the payment card;
receive payment card information, including information corresponding to an owner of the payment card;
receive at least one image, the at least one image corresponding to the payment card, the user, or both the payment card and the user;
analyze the identifier to determine an entity associated with the smart device;
determine whether the entity is the user;
analyze the payment card information to determine whether the user is the owner of the payment card;
associate the transaction code to the user;
analyze the at least one image to determine whether the image is associated with the user, the payment card, the smart device, or any combination of the user, the payment card and the smart device;
upon determining an association between the image and the user, and between the image and the smart device or the smart device and the user, send an authentication code to the smart device and to the merchant.

2. The system of claim 1, wherein the image is a photograph of a hologram.

3. The system of claim 1, wherein the smart device includes a camera for obtaining the image.
